(19) United States
(12) Patent Application Publication
(10) Pub. No.: US 2024/0305736 A1
(43) Pub. Date: Sep. 12, 2024

(54) METHOD OF PROCESSING VIDEO FRAME, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yanlong ZHANG, Beijing (CN); HU Weidong, Beijing (CN); ZHANG Qi, Beijing (CN)

(73) Assignee: BEIJING BAIDU NETCOM SCIENCE TECHNOLOGY CO., LTD., Beijing (CN)

(21) Appl. No.: 18/020,832

(22) PCT Filed: May 18, 2022
(86) PCT No.: PCT/CN2022/093457

§ 371 Date: Feb. 10, 2023

(30) Foreign Application Priority Data
Sep. 29, 2021 (CN) 202111156586.7

(51) Int. Cl. H04N 1/60; G06T 5/20; G06V 10/56; G06V 10/60

(52) U.S. Cl. CPC H04N 1/6002; G06T 5/20; G06V 10/56; G06V 10/60

(57) ABSTRACT

A method of processing a video frame, an electronic device, and a storage medium, which relate to a field of an artificial intelligence technology, in particular to fields of computer vision and deep learning technologies, and may be applied to image processing, image recognition and other scenarios. A specific implementation solution includes: determining an enhancement configuration information in response to an image enhancement request for an initial video frame, wherein the enhancement configuration information includes an information related to adjusting a current attribute value of at least one image attribute of the initial video frame to a target attribute value, and adjusting, by using an image enhancement tool, the current attribute value of the at least one image attribute of the initial video frame according to the enhancement configuration information, so as to obtain a target video frame, wherein the image enhancement tool supports an encryption function.

This application claims priority to Chinese Patent Application No. 202111156586.7 filed on Sep. 29, 2021, which is incorporated herein by reference in its entirety.

### TECHNICAL FIELD

The present disclosure relates to a field of an artificial intelligence technology, in particular to fields of computer vision and deep learning technologies, and may be applied to image processing, image recognition and other scenarios. Specifically, the present disclosure relates to a method and an apparatus of processing a video frame, an electronic device, and a storage medium.

### BACKGROUND

A computer vision technology and a video technology are widely used in various fields, such as video entertainment, remote video chat, automatic assisted driving, traffic safety monitoring, and so on. Various image data are obtained in these applications, and the obtained image data may be displayed to meet application requirements.

### SUMMARY

The present disclosure provides a method and an apparatus of processing a video frame, an electronic device, and a storage medium.

According to an aspect of the present disclosure, a method of processing a video frame is provided, including: determining an enhancement configuration information in response to an image enhancement request for an initial video frame, wherein the enhancement configuration information includes an information related to adjusting a current attribute value of at least one image attribute of the initial video frame to a target attribute value; and adjusting, by using an image enhancement tool, the current attribute value of the at least one image attribute of the initial video frame according to the enhancement configuration information, so as to obtain a target video frame, wherein the image enhancement tool supports an encryption function.

According to another aspect of the present disclosure, an apparatus of processing a video frame is provided, including: a response module configured to determine an enhancement configuration information in response to an image enhancement request for an initial video frame, wherein the enhancement configuration information includes an information related to adjusting a current attribute value of at least one image attribute of the initial video frame to a target attribute value; and an adjustment module configured to adjust, by using an image enhancement tool, the current attribute value of the at least one image attribute of the initial video frame according to the enhancement configuration information, so as to obtain a target video frame, wherein the image enhancement tool supports an encryption function.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method described above.

According to another aspect of the present disclosure, a non-transitory computer-readable storage medium having computer instructions therein is provided, and the computer instructions are configured to cause a computer to implement the method described above.

According to another aspect of the present disclosure, a computer program product containing a computer program is provided, and the computer program, when executed by a processor, causes the processor to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method and an apparatus of processing a video frame may be applied according to embodiments of the present disclosure;

FIG. 2 schematically shows a flowchart of a method of processing a video frame according to embodiments of the present disclosure;

FIG. 3 schematically shows a schematic diagram of a process of processing a video frame according to embodiments of the present disclosure;

FIG. 4 schematically shows a block diagram of an apparatus of processing a video frame according to embodiments of the present disclosure; and

FIG. 5 schematically shows a block diagram of an electronic device for implementing a method of processing a video frame according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

An image acquisition may be affected by an intensity of ambient light, a performance of a display device and other factors, resulting in a low contrast, a color distortion and a low definition of an image, which brings difficulties to a visual observation of a user and an analysis and processing of the image. Therefore, there is a need to perform an image enhancement on the image.

The image enhancement may be a method to highlight a feature of interest in an image or suppress some undesired features in an image according to a predetermined need, so that the image is matched with visual response characteristics. The image enhancement may be a pre-processing operation of image analysis and image processing. A video may contain a plurality of video frames, and each video frame is an image.

The image enhancement for a mobile terminal may be implemented by the following methods.

In a first method, the image enhancement is performed on the video frame by using an image enhancement tool developed based on OpenGL Shader before the video is decoded.

In a second method, a pre-processing operation is performed on the video frame after the video is decoded, and the image enhancement is performed on the pre-processed video frame by using a deep learning model.

In a process of implementing concepts of the present disclosure, it is found that for the first method, OpengGL Shader is easy to be cracked by third-party software. For example, the third-party software may be SnapdragonProfiler. A specific implementation of the image enhancement tool developed based on OpenGL Shader may be acquired using SnapdragonProfiler. Therefore, the image enhancement implemented by the first method has a low security.

For the second method, the terminal device is required to have a high-performance CPU or GPU (Graphics Processing Unit) to effectively ensure a real-time performance of the image enhancement. Since a performance of the terminal device is not high, the image enhancement implemented by the second method has a poor real-time performance.

To this end, embodiments of the present disclosure propose a solution for performing an image enhancement by using an image enhancement tool that may achieve an encryption function. That is, an enhancement configuration information is determined in response to an image enhancement request for an initial video frame. The enhancement configuration information includes an information related to adjusting a current attribute value of at least one image attribute of the initial video frame to a target attribute value. The current attribute value of the at least one image attribute of the initial video frame is adjusted according to the enhancement configuration information by using an image enhancement tool that supports an encryption function, so as to obtain a target video frame. Since the image enhancement tool supports an encryption function, it is difficult to crack the process of adjusting the current attribute value of the image attribute of the initial video frame to the target attribute value to obtain the target video frame by using the image enhancement tool, so that the security of the image enhancement may be improved. In addition, since no deep learning model is used in the implementation of the image enhancement, a performance requirement for the terminal device is not high. Therefore, the real-time performance of the image enhancement may be effectively ensured in a case of a low performance of the terminal device.

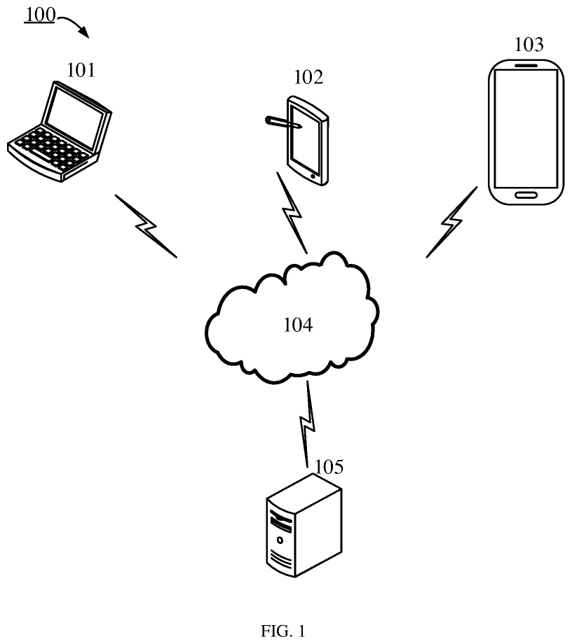

FIG. 1 schematically shows an exemplary system architecture to which a method and an apparatus of processing a video frame may be applied according to embodiments of the present disclosure.

It should be noted that FIG. 1 is merely an example of a system architecture to which embodiments of the present disclosure may be applied to help those skilled in the art understand technical contents of the present disclosure, but it does not mean that embodiments of the present disclosure may not be applied to other devices, systems, environments or scenarios. For example, in other embodiments, an exemplary system architecture to which a method and an apparatus of processing a video frame may be applied may include a terminal device, but the terminal device may implement the content processing method and processing apparatus provided in embodiments of the present disclosure without interacting with a server.

As shown in FIG. 1, a system architecture 100 according to such embodiments may include terminal devices 101, 102, 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to send or receive messages, etc. The terminal devices 101, 102 and 103 may be installed with various communication client applications, such as knowledge reading applications, web browser applications, search applications, instant messaging tools, mailbox clients and/or social platform software, etc. (just for example).

The terminal devices 101, 102 and 103 may be various electronic devices having display screens and supporting web browsing, including but not limited to smart phones, tablet computers, laptop computers, desktop computers, and so on.

The server 105 may be various types of servers providing various services, such as a background management server (just for example) that provides a support for a content browsed by the user using the terminal devices 101, 102 and 103. The background management server may analyze and process a received user request and other data, and feed back a processing result (e.g., a webpage, an information or data acquired or generated according to the user request) to the terminal devices.

The server 105 may be a cloud server, also known as a cloud computing server or a cloud host, which is a host product in a cloud computing service system to solve shortcomings of difficult management and weak service scalability existing in an existing physical host and VPS (Virtual Private Server) service. The server 105 may also be a server of a distributed system or a server combined with a block-chain.

It should be noted that the method of processing the video frame provided by embodiments of the present disclosure may generally be performed by the terminal device 101, 102 or 103. Accordingly, the apparatus of processing the video frame provided by embodiments of the present disclosure may also be arranged in the terminal device 101, 102 or 103.

Alternatively, the method of processing the video frame provided by embodiments of the present disclosure may generally be performed by the server 105. Accordingly, the apparatus of processing the video frame provided by embodiments of the present disclosure may be generally arranged in the server 105. The method of processing the video frame provided by embodiments of the present disclosure may also be performed by a server or server cluster different from the server 105 and capable of communicating with the terminal devices 101, 102, 103 and/or the server 105. Accordingly, the apparatus of processing the video frame provided by embodiments of the present disclosure may also be arranged in a server or server cluster different from the server 105 and capable of communicating with the terminal devices 101, 102, 103 and/or the server 105.

For example, the server 105 may determine an enhancement configuration information in response to an image enhancement request for an initial video frame, and adjusting a current attribute value of at least one image attribute of the initial video frame to obtain a target video frame according to the enhancement configuration information by using an image enhancement tool. Alternatively, a server or server cluster capable of communicating with the terminal devices 101, 102, 103 and/or the server 105 may respond to the image enhancement request for the initial video frame, and finally obtain the target video frame.

It should be understood that a number of terminal devices, network and server in FIG. 1 are merely schematic. According to implementation needs, any number of terminal devices, networks and servers may be provided.

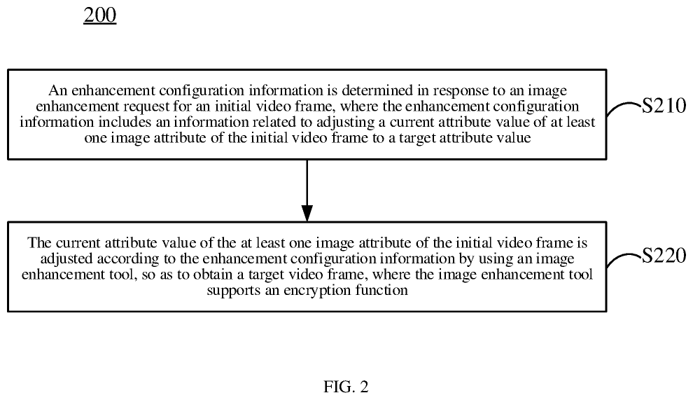

FIG. 2 schematically shows a flowchart of a method of processing a video frame according to embodiments of the present disclosure.

As shown in FIG. 2, a method 200 may include operation S210 to operation S220.

In operation S210, an enhancement configuration information is determined in response to an image enhancement request for an initial video frame. The enhancement configuration information includes an information related to adjusting a current attribute value of at least one image attribute of the initial video frame to a target attribute value.

In operation S220, the current attribute value of the at least one image attribute of the initial video frame is adjusted according to the enhancement configuration information by using an image enhancement tool, so as to obtain a target video frame. The image enhancement tool supports an encryption function.

According to embodiments of the present disclosure, a video may contain a plurality of video frames arranged according to time stamps. The initial video frame may be any one of a plurality of video frames contained in the video. The image enhancement request may be a request to perform an image enhancement. The enhancement configuration information may include an information for adjusting an attribute value of at least one image attribute of the initial video frame from a current attribute value to a target attribute value. The initial video frame may refer to a video frame before the image enhancement is performed. The target video frame may refer to a video frame after the image enhancement is performed. The image attribute may include at least one selected from: an image luminance, an image definition, an image saturation, an image contrast, or an image resolution. The current attribute value may refer to an attribute value corresponding to the image attribute in the initial video frame. The target attribute value may refer to an attribute value corresponding to the image attribute in the target video frame. Accordingly, the enhancement configuration information may include at least one selected from: a luminance configuration information, a definition configuration information, a saturation configuration information, a contrast configuration information, or a resolution configuration information.

According to embodiments of the present disclosure, the image enhancement tool may be an image enhancement tool developed based on a development language and supporting an encryption function. The development language may include an open computing language (OpenCL) or a Metal language. “The image enhancement tool supports an encryption function” may mean that the image enhancement tool itself is encrypted. “The image enhancement tool itself is encrypted” may mean that a specific implementation of the image enhancement tool may not be obtained from outside. Alternatively, “the image enhancement tool supports an encryption function” may mean that the image enhancement tool itself is not encrypted, but an encryption is achieved using an authentication strategy.

According to embodiments of the present disclosure, the image enhancement tool supporting an encryption may be implemented using the authentication strategy, that is, a trusted user allowed to perform an image enhancement using the image enhancement tool may be pre-determined. A user may be represented by a user identification. The authentication strategy may be used to verify whether a user is a trusted user. If it is determined that a user identification contained in an authentication request is a trusted user identification in response to the authentication request of the user, the user corresponding to the user identification may be determined as a trusted user. If it is determined that the user is a trusted user, an image enhancement may be performed using the image enhancement tool.

According to embodiments of the present disclosure, an image enhancement request for the initial video frame may be acquired, and the enhancement configuration information may be determined in response to the image enhancement request. Determining the enhancement configuration information in response to the image enhancement request may include parsing the image enhancement request to obtain the enhancement configuration information, that is, the image enhancement request may carry the enhancement configuration information. Alternatively, in response to the image enhancement request, an enhancement configuration information corresponding to the image enhancement request may be generated according to an information of the image enhancement request.

According to embodiments of the present disclosure, the image enhancement tool may be invoked after the enhancement configuration information is determined. For each of the at least one image attribute, the current attribute value of the image attribute may be adjusted to the target attribute value according to the enhancement configuration information corresponding to the image attribute by using the image enhancement tool. When the current attribute value of each image attribute is adjusted to the target attribute value, the image enhancement operation for the initial video frame is completed, and the target video frame is obtained. That is, the attribute value of each image attribute in the target video frame is the target attribute value.

According to embodiments of the present disclosure, an enhancement configuration information is determined in response to an image enhancement request for an initial video frame, and a current attribute value of at least one image attribute of the initial video frame is adjusted according to the enhancement configuration information by using an image enhancement tool supporting an encryption function, so as to obtain a target video frame. Since the image enhancement tool supports an encryption function, it is difficult to crack the process of adjusting the current attribute value of the image attribute of the initial video frame to the target attribute value to obtain the target video frame by using the image enhancement tool, so that the security of the image enhancement may be improved. In addition, since no deep learning model is used in the implementation of the image enhancement, a performance requirement for the terminal device is not high. Therefore, the real-time performance of the image enhancement may be effectively ensured in a case of a low performance of the terminal device.

According to embodiments of the present disclosure, the above-mentioned method of processing the video frame may further include the following operations.

A source code corresponding to an image enhancement operation is determined. The source code is compiled to obtain a library file. The library file is determined as the image enhancement tool.

According to embodiments of the present disclosure, the source code corresponding to the image enhancement operation may refer to a code written for the image enhancement operation based on a development language. The development language may include an open computing language or a Metal language. The development language may be selected according to an operating system of the terminal device. For example, if the operating system of the terminal device is an Android system, the image enhancement tool may be developed based on the open computing language. If the operating system of the terminal device is an iOS system, the image enhancement tool may be developed based on the Metal language.

According to embodiments of the present disclosure, the library file may contain resources related to the image enhancement operation, such as functions and variables. The library file may include a static library file and a dynamic library file.

According to embodiments of the present disclosure, the image enhancement operation may be obtained, and the source code corresponding to the image enhancement operation may be determined. After the source code corresponding to the image enhancement operation is determined, the source code may be compiled by a compiler to obtain a library file, and the library file may be determined as the image enhancement tools.

According to embodiments of the present disclosure, the image enhancement tool in a form of a library file makes it difficult to obtain the specific implementation of the image enhancement tool from outside. Therefore, it is difficult to crack the process of adjusting the current attribute value of the image attribute of the initial video frame to the target attribute value to obtain the target video frame by using the image enhancement tool, so that the security of the image enhancement may be improved.

According to embodiments of the present disclosure, operation S210 may include the following operations.

The respective current attribute values of the plurality of image attributes of the initial video frame are respectively adjusted according to a predetermined processing order and the enhancement configuration information, so as to obtain the target video frame.

According to embodiments of the present disclosure, the predetermined processing order may refer to an order in which the image enhancement operation is performed on the plurality of image attributes. The predetermined processing order may be configured according to actual service requirements, which is not limited here. For example, the image attribute may include an image luminance, an image definition, and an image saturation. The predetermined processing order may be a processing order in which an image enhancement operation for the image luminance, an image enhancement operation for the image definition and an image enhancement operation for the image saturation are arranged. For example, the predetermined processing order may be that the image enhancement operation for the image definition, the image enhancement operation for the image luminance and the image enhancement operation for the image saturation are performed sequentially. The predetermined processing order may also be that the image enhancement operation for the image saturation, the image enhancement operation for the image luminance and the image enhancement operation for the image definition are performed sequentially.

According to embodiments of the present disclosure, the predetermined processing order may be that the image enhancement operation for the image definition, the image enhancement operation for the image luminance and the image enhancement operation for the image saturation are performed sequentially. Adjusting the respective current attribute values of the plurality of image attributes of the initial video frame respectively to obtain the target video frame according to the predetermined processing order and the enhancement configuration information may include the following operations. The initial video frame is converted from a first color space to a second color space to obtain a first intermediate video frame; the current attribute value of the image definition of the first intermediate video frame is adjusted to the target attribute value according to the definition configuration information, so as to obtain a fifth intermediate video frame; the current attribute value of the image luminance of the fifth intermediate video frame is adjusted to the target attribute value according to the luminance configuration information, so as to obtain a sixth intermediate video frame; the sixth intermediate video frame is converted from the second color space to the first color space to obtain a seventh intermediate video frame; the current attribute value of the image saturation of the seventh intermediate video frame is adjusted to the target attribute value according to the saturation configuration information, so as to obtain the target video frame.

According to embodiments of the present disclosure, the plurality of image attributes include the image luminance, the image definition, and the image saturation. The enhancement configuration information includes the luminance configuration information, the definition configuration information, and the saturation configuration information.

According to embodiments of the present disclosure, adjusting the respective current attribute values of the plurality of image attributes of the initial video frame respectively to obtain the target video frame according to the predetermined processing order and the enhancement configuration information may include the following operations.

The initial video frame is converted from the first color space to the second color space to obtain a first intermediate video frame. The current attribute value of the image luminance of the first intermediate video frame is adjusted to the target attribute value according to the luminance configuration information, so as to obtain a second intermediate video frame. The current attribute value of the image definition of the second intermediate video frame is adjusted to the target attribute value according to the definition configuration information, so as to obtain a third intermediate video frame. The third intermediate video frame is converted from the second color space to the first color space to obtain a fourth intermediate video frame. The current attribute value of the image saturation of the fourth intermediate video frame is adjusted to the target attribute value according to the saturation configuration information, so as to obtain the target video frame.

According to embodiments of the present disclosure, the luminance configuration information may be an enhancement configuration information corresponding to the image enhancement operation on the image luminance of the video frame. The luminance configuration information may include at least one mapping relationship information, and each mapping relationship information indicates a mapping relationship between an unadjusted value and an adjusted value of the image luminance. Alternatively, the luminance configuration information may include a luminance mapping function. The definition configuration information may be an enhancement configuration information corresponding to the image enhancement operation on the definition of the video frame. The saturation configuration information may be an enhancement configuration information corresponding to the image enhancement operation on the saturation of the video frame.

According to embodiments of the present disclosure, the first color space may include an HSV color space, a YUV color space, or other color spaces containing a luminance information. The second color space may include a BGR color space, an RGB color space, or other color spaces.

According to embodiments of the present disclosure, a first color space conversion routine may be called, and the initial video frame may be converted from the first color space to the second color space by using the first color space conversion routine, so as to obtain the first intermediate video frame. When the first intermediate video frame is obtained, adjusting the current attribute value of the image luminance of the first intermediate video frame to the target attribute value to obtain the second intermediate video frame according to the luminance configuration information may include: adjusting the current attribute value of the image luminance of the first intermediate video frame to the target attribute value according to the luminance mapping function, so as to obtain the second intermediate video frame, that is, the current attribute value of the image luminance of the first intermediate video frame is input into the luminance mapping function to obtain the second intermediate video frame, and the attribute value of the image luminance of the second intermediate video frame is the target attribute value. Alternatively, it is possible to search for an unadjusted value matched with the current attribute value of the image luminance from the at least one mapping relationship information according to the current value of the image luminance. An adjusted value having a mapping relationship with a target unadjusted value may be determined as the target attribute value corresponding to the image luminance. The current attribute value of the image luminance of the first intermediate video frame is adjusted to the target attribute value to obtain the second intermediate video frame.

According to embodiments of the present disclosure, when the first intermediate video frame is obtained, the current attribute value of the image definition of the second intermediate video frame may be adjusted to the target attribute value according to the definition configuration information, so as to obtain the third intermediate video frame. Then a second color space conversion routine may be called, and the third intermediate video frame may be converted from the second color space to the first color space by using the second color space conversion routine, so as to obtain the fourth intermediate video frame. Finally, the current attribute value of the image saturation of the fourth intermediate video frame may be adjusted to the target attribute value according to the saturation configuration information, so as to obtain the target video frame.

According to embodiments of the present disclosure, the current attribute value of the image attribute may be dynamically adjusted as required according to the enhancement configuration information, so as to obtain the image-enhanced target video frame. Therefore, an image quality may be improved, thereby improving a viewing experience of the user. In addition, a video stream with the same image quality may save a network transmission bandwidth and reduce traffic.

According to embodiments of the present disclosure, the luminance configuration information may include at least one mapping relationship information, and each mapping relationship information indicates a mapping relationship between an unadjusted value and an adjusted value of the image luminance.

According to embodiments of the present disclosure, adjusting the current attribute value of the image luminance of the first intermediate video frame to the target attribute value to obtain the second intermediate video frame according to the luminance configuration information may include the following operations.

An unadjusted value matched with the current attribute value of the image luminance is searched from the at least one mapping relationship information according to the current value of the image luminance. An adjusted value having a mapping relationship with a target unadjusted value is determined as the target attribute value corresponding to the image luminance. The current attribute value of the image luminance of the first intermediate video frame is adjusted to the target attribute value to obtain the second intermediate video frame.

According to embodiments of the present disclosure, for example, the current attribute value of the image luminance is a current attribute value a. An unadjusted value b and an adjusted value c of the image luminance have a mapping relationship. The current attribute value a is matched with the unadjusted value b.

The unadjusted value b matched with the current attribute value a of the image luminance may be found from the at least one mapping relationship information. The adjusted value c having a mapping relationship with the unadjusted value b is determined as the target attribute value of the image luminance. The current attribute value a of the image luminance of the first intermediate video frame is adjusted to the target attribute value, i.e., the adjusted value c, so as to obtain the second intermediate video frame.

According to embodiments of the present disclosure, the definition configuration information may include a de-noising parameter.

According to embodiments of the present disclosure, adjusting the current attribute value of the image definition of the second intermediate video frame to the target attribute value to obtain the third intermediate video frame according to the definition configuration information may include the following operations.

The second intermediate video frame is convolved with the de-noising parameter to obtain the third intermediate video frame.

According to embodiments of the present disclosure, the de-noising parameter may include a mean de-noising parameter, a median de-noising parameter or a Gaussian de-noising parameter, which may be configured according to actual service requirements and is not limited here.

According to embodiments of the present disclosure, the saturation configuration information may include a saturation coefficient.

According to embodiments of the present disclosure, adjusting the current attribute value of the image saturation of the fourth intermediate video frame to the target attribute value to obtain the target video frame according to the saturation configuration information may include the following operations.

The current attribute value of the image saturation of the fourth intermediate video frame is adjusted to the target attribute value according to the saturation coefficient and the current attribute value of the image saturation of the fourth intermediate video frame, so as to obtain the target video frame.

According to embodiments of the present disclosure, the saturation coefficient may be used to adjust the current attribute value of the image saturation to the target attribute value. The saturation coefficient may be configured according to actual service requirements, which is not limited here. For example, the saturation coefficient may be 1.65. The current attribute value of the image saturation may include a first current component value, a second current component value, and a third current component value.

According to embodiments of the present disclosure, adjusting the current attribute value of the image saturation of the fourth intermediate video frame to the target attribute value to obtain the target video frame according to the saturation coefficient and the current attribute value of the image saturation of the fourth intermediate video frame may include: with the third current component value of the image saturation of the fourth intermediate video frame being kept unchanged, multiplying the saturation coefficient respectively with the first current component value and the second current component value of the image saturation of the fourth intermediate video frame, so as to obtain the target video frame. The target attribute value of the image saturation includes the third current component value, a value obtained by multiplying the first current component value by the saturation coefficient, and a value obtained by multiplying the second current component value by the saturation coefficient.

According to embodiments of the present disclosure, the first color space includes a YUV color space, and the second color space includes a BGR color space.

According to embodiments of the present disclosure, the YUV color space may be a color space in which a color is described by luminance-chromatism. The YUV color space may contain Y (Luminance), U (Chrominance) and V (Chroma). The BGR color space may contain B (Blue), G (Green) and R (Red).

According to embodiments of the present disclosure, in a case that the first color space is the YUV color space, the current attribute value of the image saturation may include the first current component value, the second current component value and the third current component value. The first current component value may be a U component value. The second current component value may be a V component value. The third current component value may include a Y component value. Adjusting the current attribute value of the image saturation of the fourth intermediate video frame to the target attribute value to obtain the target video frame according to the saturation coefficient and the current attribute value of the image saturation of the fourth intermediate video frame may include: with the Y component value of the image saturation of the fourth intermediate video frame being kept unchanged, multiplying the saturation coefficient respectively with the U component value of the image saturation of the fourth intermediate video frame and the V component value of the image saturation of the fourth intermediate video frame, so as to obtain the target video frame.

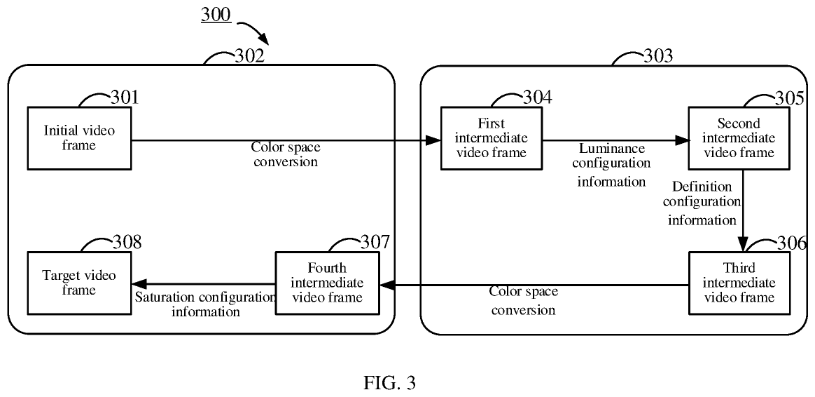

The method of processing the video frame in embodiments of the present disclosure will be further described below with reference to FIG. 3 in conjunction with specific embodiments.

FIG. 3 schematically shows a schematic diagram of a process of processing a video frame according to embodiments of the present disclosure.

As shown in FIG. 3, in 300, an initial video frame 301 is converted from a first color space 302 to a second color space 303 to obtain a first intermediate video frame 304. The current attribute value of the image luminance of the first intermediate video frame 304 is adjusted to the target attribute value according to the luminance configuration information, so as to obtain a second intermediate video frame 305. The current attribute value of the image definition of the second intermediate video frame 305 is adjusted to the target attribute value according to the definition configuration information, so as to obtain a third intermediate video frame 306. The third intermediate video frame 306 is converted from the second color space 303 to the first color space 302 to obtain a fourth intermediate video frame 307. The current attribute value of the image saturation of the fourth intermediate video frame 307 is adjusted to the target attribute value according to the saturation configuration information, so as to obtain a target video frame 308.

The above are merely exemplary embodiments, but the present disclosure is not limited thereto and may further include other methods of processing video frames known in the art, as long as the processing of video frame may be achieved.

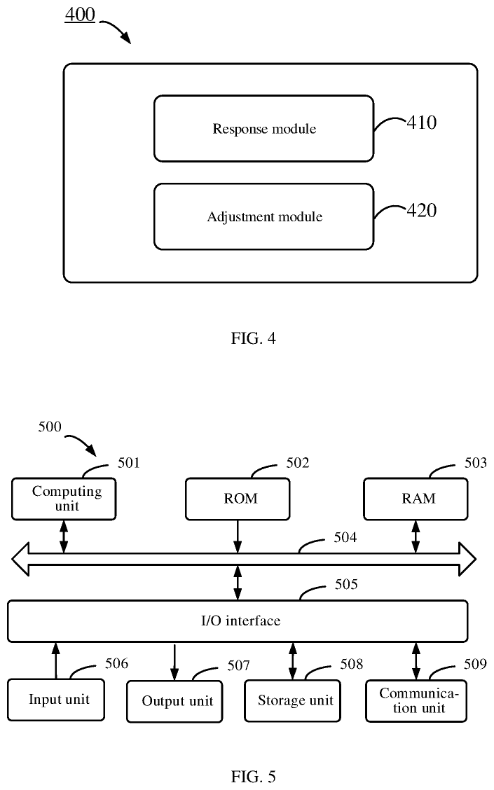

FIG. 4 schematically shows a block diagram of an apparatus of processing a video frame according to embodiments of the present disclosure.

As shown in FIG. 4, an apparatus 400 of processing a video frame may include a response module 410 and an adjustment module 420.

The response module 410 may be used to determine an enhancement configuration information in response to an image enhancement request for an initial video frame. The enhancement configuration information includes an information related to adjusting a current attribute value of at least one image attribute of the initial video frame to a target attribute value.

The adjustment module 420 may be used to adjust, by using an image enhancement tool, the current attribute value of the at least one image attribute of the initial video frame according to the enhancement configuration information, so as to obtain a target video frame. The image enhancement tool supports an encryption function.

According to embodiments of the present disclosure, the apparatus 400 of processing the video frame may further include a first determination module, a compiling module, and a second determination module.

The first determination module may be used to determine a source code for an image enhancement operation.

The compiling module may be used to compile the source code to obtain a library file.

The second determination module may be used to determine the library file as the image enhancement tool.

According to embodiments of the present disclosure, the adjustment module 420 may include an adjustment sub-module.

The adjustment sub-module may be used to adjust respective current attribute values of a plurality of image attributes of the initial video frame respectively according to a predetermined processing order and the enhancement configuration information, so as to obtain the target video frame.

According to embodiments of the present disclosure, the plurality of image attributes include an image luminance, an image definition, and an image saturation. The enhancement configuration information includes a luminance configuration information, a definition configuration information, and a saturation configuration information.

According to embodiments of the present disclosure, the adjustment sub-module may include a first conversion unit, a first adjustment unit, a second adjustment unit, a second conversion unit, and a third adjustment unit.

The first conversion unit may be used to convert the initial video frame from a first color space to a second color space to obtain a first intermediate video frame.

The first adjustment unit may be used to adjust the current attribute value of the image luminance of the first intermediate video frame to the target attribute value according to the luminance configuration information, so as to obtain a second intermediate video frame.

The second adjustment unit may be used to adjust the current attribute value of the image definition of the second intermediate video frame to the target attribute value according to the definition configuration information, so as to obtain a third intermediate video frame.

The second conversion unit may be used to convert the third intermediate video frame from the second color space to the first color space to obtain a fourth intermediate video frame.

The third adjustment unit may be used to adjust the current attribute value of the image saturation of the fourth intermediate video frame to the target attribute value according to the saturation configuration information, so as to obtain the target video frame.

According to embodiments of the present disclosure, the luminance configuration information includes at least one mapping relationship information, and each mapping relationship information indicates a mapping relationship between an unadjusted value of the image luminance and an adjusted value of the image luminance.

According to embodiments of the present disclosure, the first adjustment unit may include a search sub-unit, a determination sub-unit, and a first adjustment sub-unit.

The search sub-unit may be used to search for, from the at least one mapping relationship information, the unadjusted value matched with the current attribute value of the image luminance, according to the current value of the image luminance.

The determination sub-unit may be used to determine the adjusted value having the mapping relationship with the target unadjusted value as the target attribute value of the image luminance.

The first adjustment sub-unit may be used to adjust the current attribute value of the image luminance of the first intermediate video frame to the target attribute value, so as to obtain the second intermediate video frame.

According to embodiments of the present disclosure, the definition configuration information includes a de-noising parameter.

According to embodiments of the present disclosure, the second adjustment unit may include an obtaining sub-unit.

The obtaining sub-unit may be used to convolve the second intermediate video frame with the de-noising parameter to obtain the third intermediate video frame.

According to embodiments of the present disclosure, the saturation configuration information includes a saturation coefficient.

According to embodiments of the present disclosure, the third adjustment unit may include a second adjustment sub-unit.

The second adjustment sub-unit may be used to adjust the current attribute value of the image saturation of the fourth intermediate video frame to the target attribute value according to the saturation coefficient and the current attribute value of the image saturation of the fourth intermediate video frame, so as to obtain the target video frame.

According to embodiments of the present disclosure, the first color space includes a YUV color space, and the second color space includes a BGR color space.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the methods described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program, when executed by a processor, causes the processor to implement the methods described above.

FIG. 5 schematically shows a block diagram of an electronic device suitable for implementing the method of processing the video frame according to embodiments of the present disclosure. An electronic device 500 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 501 which may perform various appropriate actions and processes according to a computer program stored in a read only memory (ROM) 502 or a computer program loaded from a storage unit 508 into a random access memory (RAM) 503. In the RAM 503, various programs and data necessary for an operation of the electronic device 500 may also be stored. The computing unit 501, the ROM 502 and the RAM 503 are connected to each other through a bus 504. An input/output (I/O) interface 505 is also connected to the bus 504.

A plurality of components in the electronic device 500 are connected to the I/O interface 505, including: an input unit 506, such as a keyboard, or a mouse; an output unit 507, such as displays or speakers of various types; a storage unit 508, such as a disk, or an optical disc; and a communication unit 509, such as a network card, a modem, or a wireless communication transceiver. The communication unit 509 allows the electronic device 500 to exchange information/data with other devices through a computer network such as Internet and/or various telecommunication networks.

The computing unit 501 may be various general-purpose and/or dedicated processing assemblies having processing and computing capabilities. Some examples of the computing units 501 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 501 executes various methods and steps described above, such as the method of processing the video frame. For example, in some embodiments, the method of processing the video frame may be implemented as a computer software program which is tangibly embodied in a machine-readable medium, such as the storage unit 508. In some embodiments, the computer program may be partially or entirely loaded and/or installed in the electronic device 500 via the ROM 502 and/or the communication unit 509. The computer program, when loaded in the RAM 503 and executed by the computing unit 501, may execute one or more steps in the method of processing the video frame described above. Alternatively, in other embodiments, the computing unit 501 may be used to perform the method of processing the video frame by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of processing a video frame, the method comprising:
determining an enhancement configuration information in response to an image enhancement request for an initial video frame, wherein the enhancement configuration information comprises an information related to adjusting a current attribute value of at least one image attribute of the initial video frame to a target attribute value; and
adjusting, by using an image enhancement tool, the current attribute value of the at least one image attribute of the initial video frame according to the enhancement configuration information, so as to obtain a target video frame, wherein the image enhancement tool supports an encryption function.

2. The method of claim 1, further comprising:
determining a source code for an image enhancement operation;
compiling the source code to obtain a library file; and
determining the library file as the image enhancement tool.

3. The method of claim 1, wherein the adjusting, by using an image enhancement tool, the current attribute value of the at least one image attribute of the initial video frame according to the enhancement configuration information, so as to obtain a target video frame comprises adjusting respective current attribute values of a plurality of image attributes of the initial video frame respectively according to a predetermined processing order and the enhancement configuration information, so as to obtain the target video frame.

4. The method of claim 3, wherein the plurality of image attributes comprise an image luminance, an image definition, and an image saturation;
the enhancement configuration information comprises a luminance configuration information, a definition configuration information, and a saturation configuration information; and
the adjusting respective current attribute values of a plurality of image attributes of the initial video frame respectively according to a predetermined processing order and the enhancement configuration information, so as to obtain the target video frame comprises:
converting the initial video frame from a first color space to a second color space to obtain a first intermediate video frame;
adjusting the current attribute value of the image luminance of the first intermediate video frame to the target attribute value according to the luminance configuration information, so as to obtain a second intermediate video frame;
adjusting the current attribute value of the image definition of the second intermediate video frame to the target attribute value according to the definition configuration information, so as to obtain a third intermediate video frame;
converting the third intermediate video frame from the second color space to the first color space to obtain a fourth intermediate video frame; and
adjusting the current attribute value of the image saturation of the fourth intermediate video frame to the target attribute value according to the saturation configuration information, so as to obtain the target video frame.

5. The method of claim 4, wherein the luminance configuration information comprises at least one mapping relationship information, and each mapping relationship information indicates a mapping relationship between an unadjusted value of the image luminance and an adjusted value of the image luminance; and
the adjusting the current attribute value of the image luminance of the first intermediate video frame to the target attribute value according to the luminance configuration information, so as to obtain a second intermediate video frame comprises:
searching for, from the at least one mapping relationship information, the unadjusted value matched with the current attribute value of the image luminance, according to the current value of the image luminance;
determining the adjusted value having the mapping relationship with a target unadjusted value as the target attribute value of the image luminance; and
adjusting the current attribute value of the image luminance of the first intermediate video frame to the target attribute value, so as to obtain the second intermediate video frame.

6. The method of claim 4, wherein the definition configuration information comprises a de-noising parameter; and
the adjusting the current attribute value of the image definition of the second intermediate video frame to the target attribute value according to the definition configuration information, so as to obtain a third intermediate video frame comprises convolving the second intermediate video frame with the de-noising parameter to obtain the third intermediate video frame.

7. The method of claim 4, wherein the saturation configuration information comprises a saturation coefficient; and
the adjusting the current attribute value of the image saturation of the fourth intermediate video frame to the target attribute value according to the saturation configuration information, so as to obtain the target video frame comprises adjusting the current attribute value of the image saturation of the fourth intermediate video frame to the target attribute value according to the saturation coefficient and the current attribute value of the image saturation of the fourth intermediate video frame, so as to obtain the target video frame.

8. The method of claim 4, wherein the first color space comprises a YUV color space, and the second color space comprises a BGR color space.

9.-16. (canceled)

17. An electronic device, comprising:
at least one processor; and
a memory communicatively connected to the at least one processor, wherein the memory stores instructions executable by the at least one processor, and the instructions, when executed by the at least one processor, cause the at least one processor to at least:
determine an enhancement configuration information in response to an image enhancement request for an initial video frame, wherein the enhancement configuration information comprises an information related to adjusting a current attribute value of at least one image attribute of the initial video frame to a target attribute value; and
adjust, by using an image enhancement tool, the current attribute value of the at least one image attribute of the initial video frame according to the enhancement configuration information, so as to obtain a target video frame, wherein the image enhancement tool supports an encryption function.

18. A non-transitory computer-readable storage medium having computer instructions therein, wherein the computer instructions are configured to cause a computer system to at least:
determine an enhancement configuration information in response to an image enhancement request for an initial video frame, wherein the enhancement configuration information comprises an information related to adjusting a current attribute value of at least one image attribute of the initial video frame to a target attribute value; and
adjust, by using an image enhancement tool, the current attribute value of the at least one image attribute of the initial video frame according to the enhancement configuration information, so as to obtain a target video frame, wherein the image enhancement tool supports an encryption function.

19. (canceled)

20. The method of claim 2, wherein the adjusting, by using an image enhancement tool, the current attribute value of the at least one image attribute of the initial video frame according to the enhancement configuration information, so as to obtain a target video frame comprises adjusting respective current attribute values of a plurality of image attributes of the initial video frame respectively according to a predetermined processing order and the enhancement configuration information, so as to obtain the target video frame.

21. The electronic device of claim 17, wherein the instructions, when executed by the at least one processor, cause the at least one processor to:
determine a source code for an image enhancement operation;
compile the source code to obtain a library file; and
determine the library file as the image enhancement tool.

22. The electronic device of claim 17, wherein the instructions, when executed by the at least one processor, cause the at least one processor to adjust respective current attribute values of a plurality of image attributes of the initial video frame respectively according to a predetermined processing order and the enhancement configuration information, so as to obtain the target video frame.

23. The non-transitory computer-readable storage medium of claim 18, wherein the instructions, when executed by the computer system, cause the computer system to adjust respective current attribute values of a plurality of image attributes of the initial video frame respectively according to a predetermined processing order and the enhancement configuration information, so as to obtain the target video frame.

24. The non-transitory computer-readable storage medium of claim 18, wherein the plurality of image attributes comprise an image luminance, an image definition, and an image saturation;
the enhancement configuration information comprises a luminance configuration information, a definition configuration information, and a saturation configuration information;
wherein the instructions, when executed by the computer system, cause the computer system to:
convert the initial video frame from a first color space to a second color space to obtain a first intermediate video frame;
adjust the current attribute value of the image luminance of the first intermediate video frame to the target attribute value according to the luminance configuration information, so as to obtain a second intermediate video frame;
adjust the current attribute value of the image definition of the second intermediate video frame to the target attribute value according to the definition configuration information, so as to obtain a third intermediate video frame;
convert the third intermediate video frame from the second color space to the first color space to obtain a fourth intermediate video frame; and
adjust the current attribute value of the image saturation of the fourth intermediate video frame to the target attribute value according to the saturation configuration information, so as to obtain the target video frame.

25. The non-transitory computer-readable storage medium of claim 18, wherein the luminance configuration information comprises at least one mapping relationship information, and each mapping relationship information indicates a mapping relationship between an unadjusted value of the image luminance and an adjusted value of the image luminance; and
wherein the instructions, when executed by the computer system, cause the computer system to:
search for, from the at least one mapping relationship information, the unadjusted value matched with the current attribute value of the image luminance, according to the current value of the image luminance;
determine the adjusted value having the mapping relationship with a target unadjusted value as the target attribute value of the image luminance; and
adjust the current attribute value of the image luminance of the first intermediate video frame to the target attribute value, so as to obtain the second intermediate video frame.

26. The non-transitory computer-readable storage medium of claim 24, wherein the definition configuration information comprises a de-noising parameter; and
wherein the instructions, when executed by the computer system, cause the computer system to convolve the second intermediate video frame with the de-noising parameter to obtain the third intermediate video frame.

27. The non-transitory computer-readable storage medium of claim 24, wherein the saturation configuration information comprises a saturation coefficient; and
wherein the instructions, when executed by the computer system, cause the computer system to adjust the current attribute value of the image saturation of the fourth intermediate video frame to the target attribute value according to the saturation coefficient and the current attribute value of the image saturation of the fourth intermediate video frame, so as to obtain the target video frame.

28. The non-transitory computer-readable storage medium of claim 24, wherein the first color space comprises a YUV color space, and the second color space comprises a BGR color space.
